(19) United States
(12) Patent Application Publication
(10) Pub. No.: US 2011/0132496 A1
(43) Pub. Date: Jun. 9, 2011

(54) Apparatus for making tenons and forming shoulders on wood ends

(76) Inventor: Leslie Gene Smith, Cut Bank, MT (US)

(21) Appl. No.: 12/928,330

(22) Filed: Dec. 9, 2010

Related U.S. Application Data
(60) Provisional application No. 61/267,880, filed on Dec. 9, 2009.

(51) Int. Cl. B27F 1/08

(52) U.S. Cl. 144/198.1

(57) ABSTRACT

Apparatus for making tenons and forming shoulders on wood ends with a stand having two opposing sides and a attachable stand top, a two piece router bracket that accepts different diameter router motors, a threaded rod bracket with at least 3 apertures for receiving a threaded rod, a threaded rod with a square tapered end, a tube connector that receives and secures smaller round diameter tubing and bolts to the top of the router bracket, a round steel slide pole, a wooden work piece holder with a round tube with a square tube attached at a 90 degree angle a a square tube with a fixed stud at one end. A preferred embodiment includes the curved thread engaging clip moves slidably on a steel rod. A preferred embodiment includes locking collars used as adjustable stops positioning the curved engaging clip in a engaging and disengaging location on the threaded rod.

### CROSS REFERENCE TO RELATED APPLICATIONS

This application is based on provisional application Ser. No. 61/267,880, filed on Dec. 9, 2009.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of mechanical technology in the field of woodworking and more specifically to a method, apparatus and system for a adjustable tenon and shoulder forming apparatus for a spindle or router motor. Mortise and tenon joints are traditional woodworking methods to provide support to structures of wood that contain right angles. Tenons are usually projections at the end of a log which may be made of timber or other wood. Traditionally, the ends of the logs have to be narrowed down to provide for a mortise and tenon joints in woodworking. Some components of the draw-joint process have been mechanized. Mortice- and tenon joints, for example, were originally cut entirely by hand.

A woodworker may use a router to place a cavity known as the mortise to create a mortise and tenon joint. Routers may be of metal or any other material know to man to serve the twin purposes of sturdiness and fitting the log end on to the router. Routers may be fitted with u-brackets or any other bracket that helps to feed log or wooden work piece ends into a router head.

Routers may be fitted with wood guides. Tenon makers use wood guides. The funnel feed into the center of the wood guide has the same profile as the router head. Wood working router motor bases are bolted to the top of the u bracket stand. Tenon Makers make common tenon diameters with radius shoulders.

However, routers fitted with wood guides may be inadequate for the current needs of the industry as they offer limited or no functionality since they require the log end to be cut square prior to placing a tenon on a log. Tenons may also need to be tapered towards the end for the purposes of the joint. The present tools offer no functionally for the purposes of making tapered tenon. To enhance each feature of a wood guide to the specifications of different router heads may be counter-productive to cost. Furthermore, the tenon makers present in the market have no specifications on how to threads on a tenon with different thread pitches. The user may also not be able to choose the option of adding threads or grooves as per specific measurements. For example the user may wish to adopt a tenon with threads for his joint which may have the necessity of a grooved tenon. However he later realizes that his tenon may need to have threads to match a threaded mortise. As such there are no tools on the market for this clear specification and hence the user may be unable to craft such a joint for his needs. Furthermore, the user may have a need of a spiral dowel pins which a normal router apparatus present may be unable to craft. The user may be at loss to craft tenons of a specific diameter. Furthermore the user may have a need to craft tenons with different types of shoulders and this need remains unfulfilled with the limitation of router apparatuses present in the market. The user may have a need to craft a interlocking tenon or a tenon with wrap around shoulders for the purposes of joints specifically mortise and tenon joints, has remained unfulfilled by present tools available in the market place.

### BRIEF SUMMARY OF THE INVENTION

The primary object of the invention is To provide a adjustable tenon and shoulder forming apparatus that can make tenons without wood guides.

Another object of the invention is To provide a adjustable tenon and shoulder forming apparatus that can form straight or tapered tenons.

Another object of the invention is To provide a adjustable tenon and shoulder forming apparatus that can form multiple tenon diameters.

A further object of the invention is To provide a apparatus that will form differently shaped shoulders using different router heads and change the profile cut of the router head.

Yet another object of the invention is To provide a adjustable tenon and shoulder forming apparatus that can form inter-locking tenons of different diameters.

Still yet another object of the invention is To provide a adjustable tenon and shoulder forming apparatus that can make wrap-around shouldered tenons.

Another object of the invention is To provide a adjustable tenon and shoulder forming apparatus that can form tenons on each end of a straight or irregular shaped work piece and keep tenons in axial alignment.

Another object of the invention is To provide a apparatus that will hold and allow rotating of a wooden work piece for forming a tenon with a shoulder.

A further object of the invention is To provide a apparatus that uses router and spindle motors with or without a depth adjustment feature.

Yet another object of the invention is To provide a apparatus that will form tenons on a wooden work piece that do not have square cut ends.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed apparatus for making tenons and forming shoulders on wood ends comprising: a stand having two opposing sides and a attachable stand top with a slot for receiving a router head, a angle bracket bolted to the base of the stand sides, a two piece router bracket that accepts different diameter router motors. A clamp for securing a router or spindle motor to the router bracket, a router or spindle motor, a router head for forming tenons and shoulders on the ends of wooden work pieces, a square steel tube with a attached angle bracket bolted to a stand side angle bracket, a threaded rod bracket with at least 3 apertures for receiving a threaded rod, square post and steel rod, a threaded rod with a square tapered end, a square steel tube bolted on the inside of a larger square steel tube with one bolt, a curved thread engaging clip with one aperture, a steel tube connector that receives and secures smaller round diameter tubing and bolts to the top of the router bracket, a round steel slide pole, a double steel tube connector that slides over smaller diameter tubing and secures one tube in a vertical position and one tube in a horizontal position, a base with a steel tube receiver that accepts smaller diameter tubing and secures the tubing in a vertical position, a adjustable wooden work piece holder with a round tube with a square tube attached at a 90 degree angle a square tube with a adjustable square tube with a fixed stud at one end.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded view of a tenon and shoulder forming apparatus in accordance with the invention.

FIG. 2 is a perspective view of the invention showing the log holder feature supporting a wooden work piece.

FIG. 3 is a perspective view of the invention illustrating how moving the threaded rod up or down creates different diameter tenons.

FIG. 4 is a perspective view of a dovetail profile router head cutting a tenon with a wrap around shoulder.

FIG. 5 is a perspective view of the thread engagement clip engaging the threaded rod of the invention.

FIG. 6 is a perspective view of the thread engagement clip disengaging the threaded rod of the invention.

FIG. 7 is a perspective view of the adjustable log holder feature of the invention.

FIG. 8 is a plan view of the two piece router bracket and hose clamp of the invention.

FIG. 9 is a perspective view of the threaded rod and straight profile router head of the invention.

FIG. 10 is a perspective view of the invention after a tapered tenon has been formed.

FIG. 11 is a perspective view of the invention showing a straight tenon with a radius shoulder has been formed.

FIG. 12 is a perspective view of the invention showing how a interlocking tenon is formed.

FIG. 13 is a perspective view of the adjustable square post of the invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

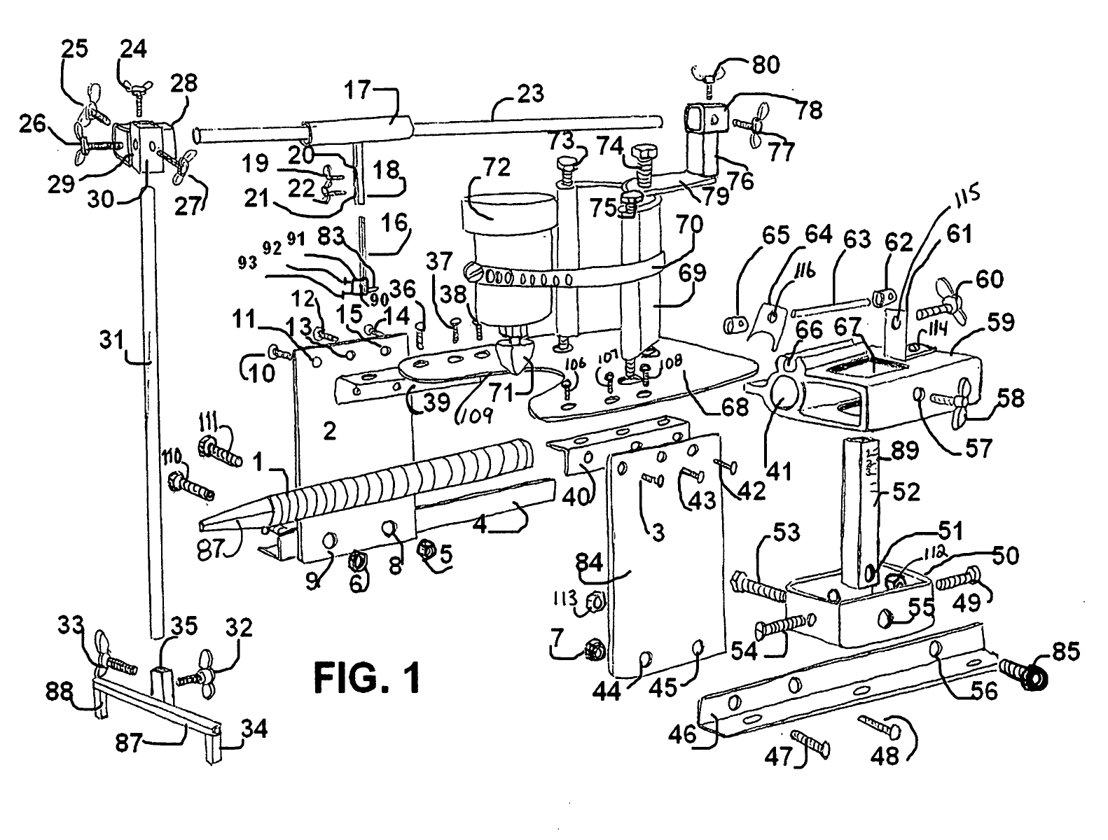

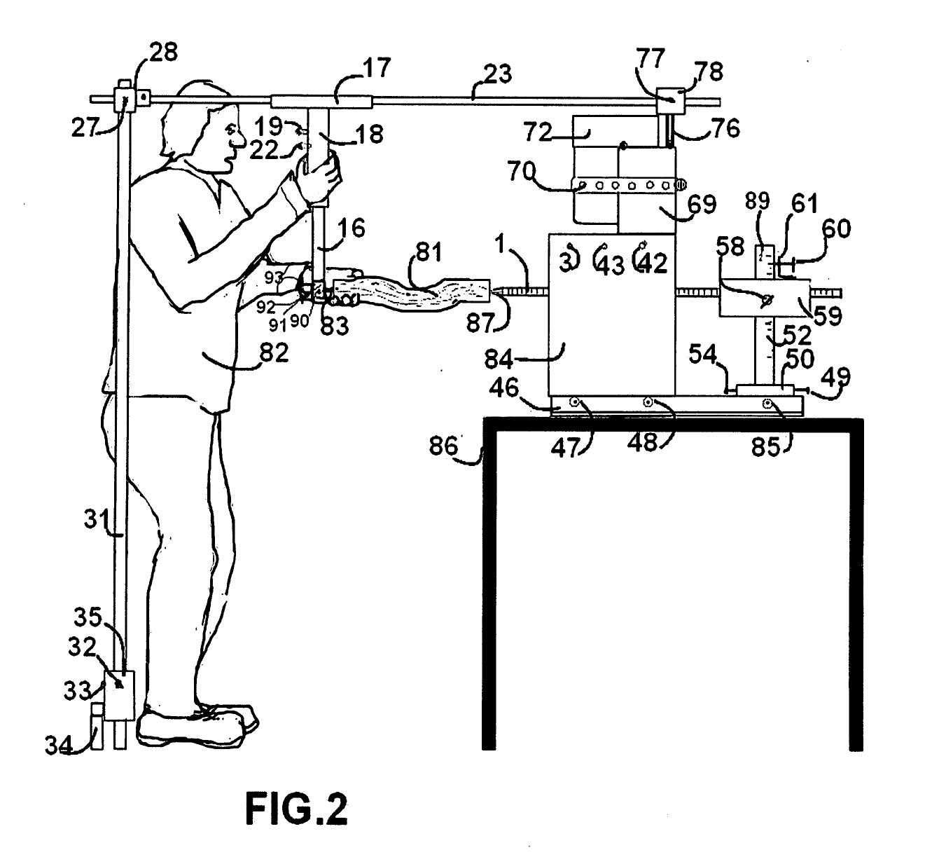

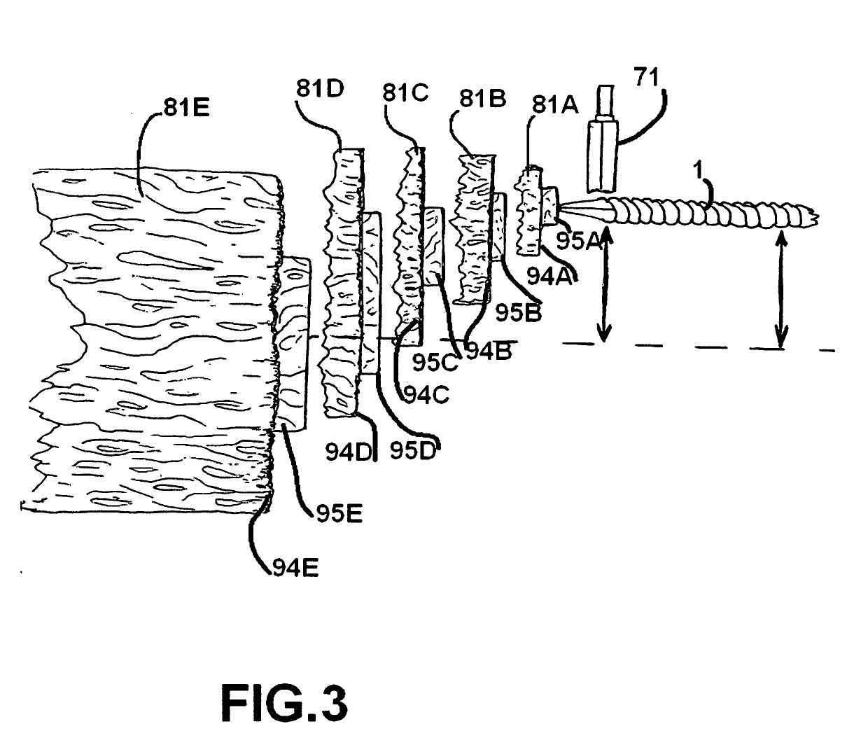

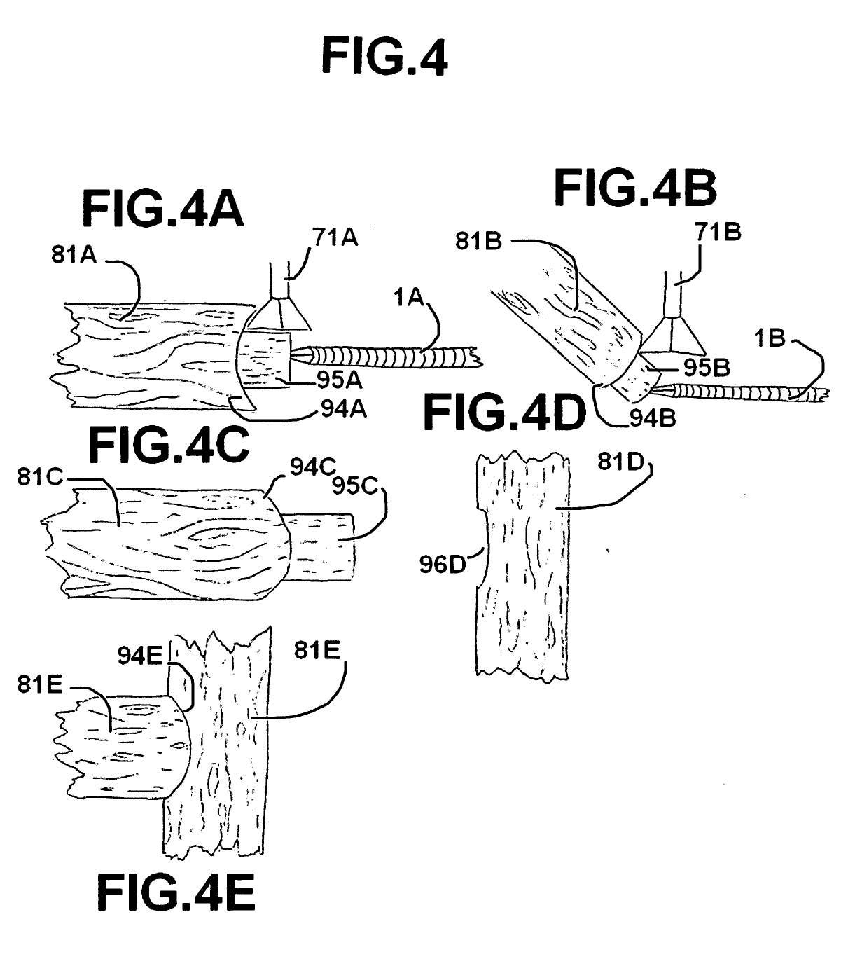

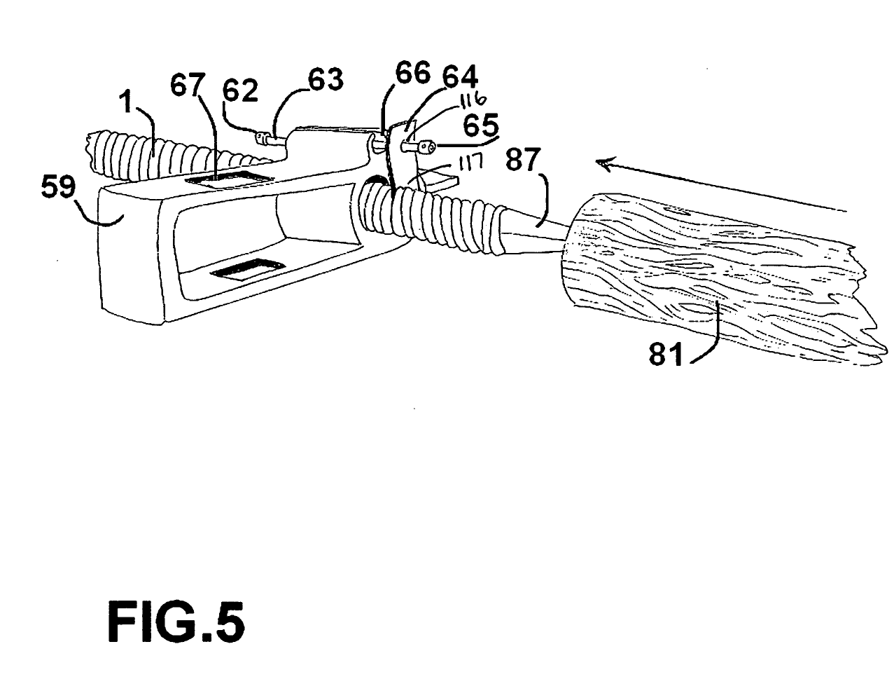

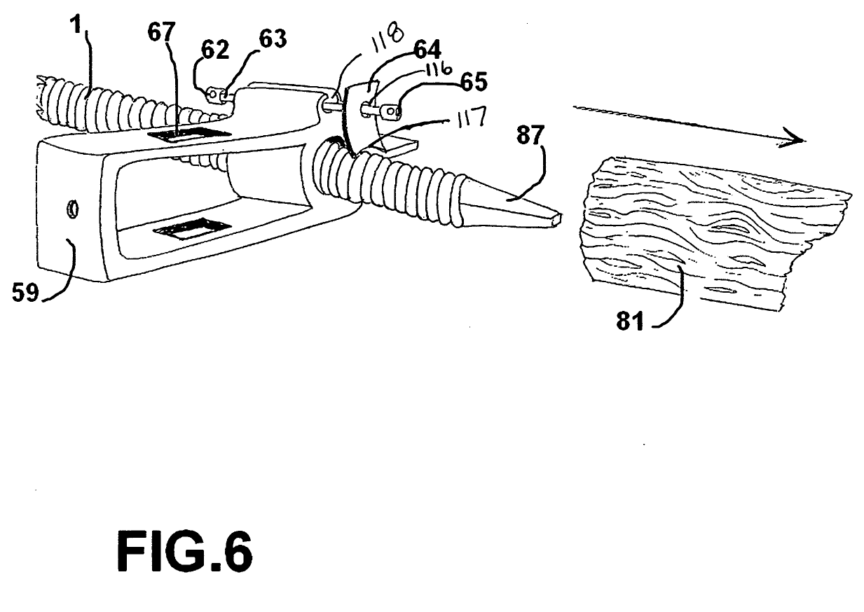

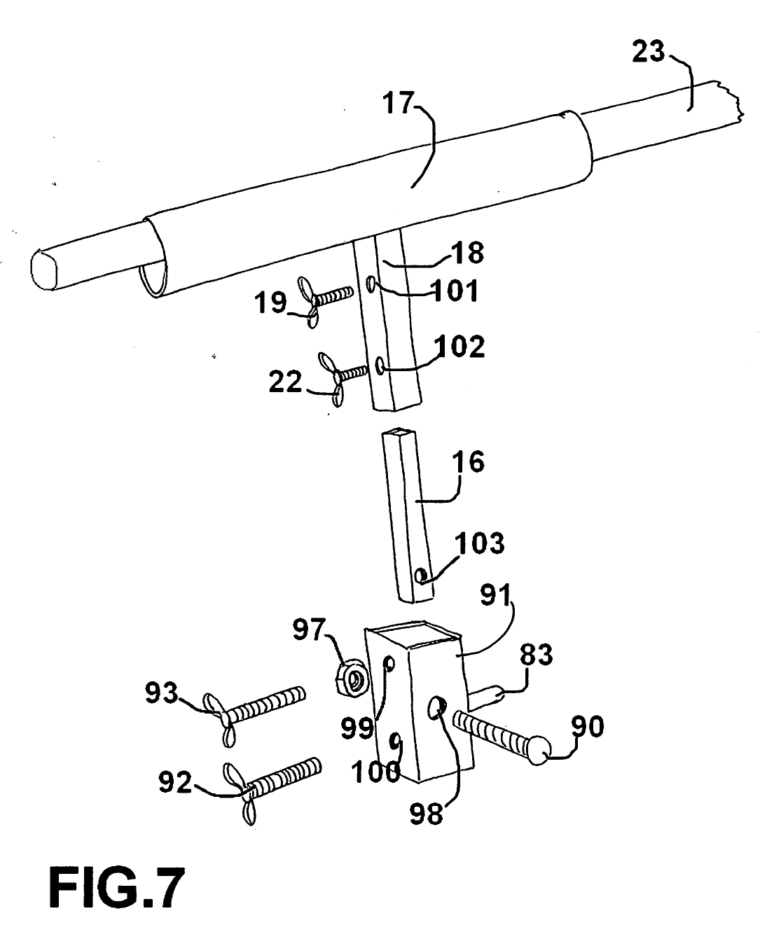

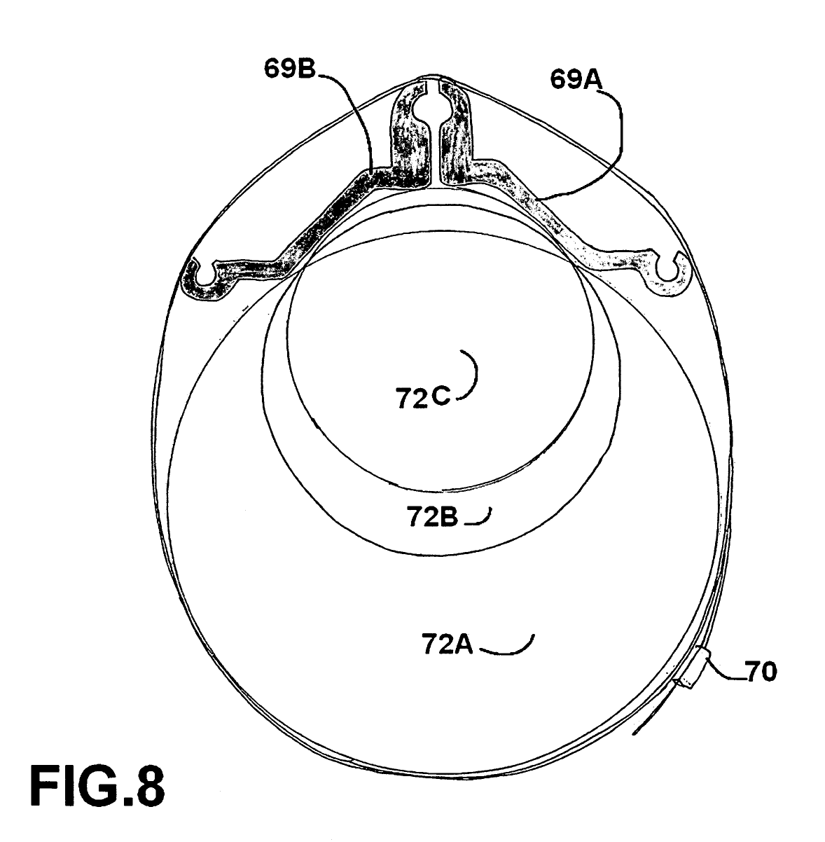

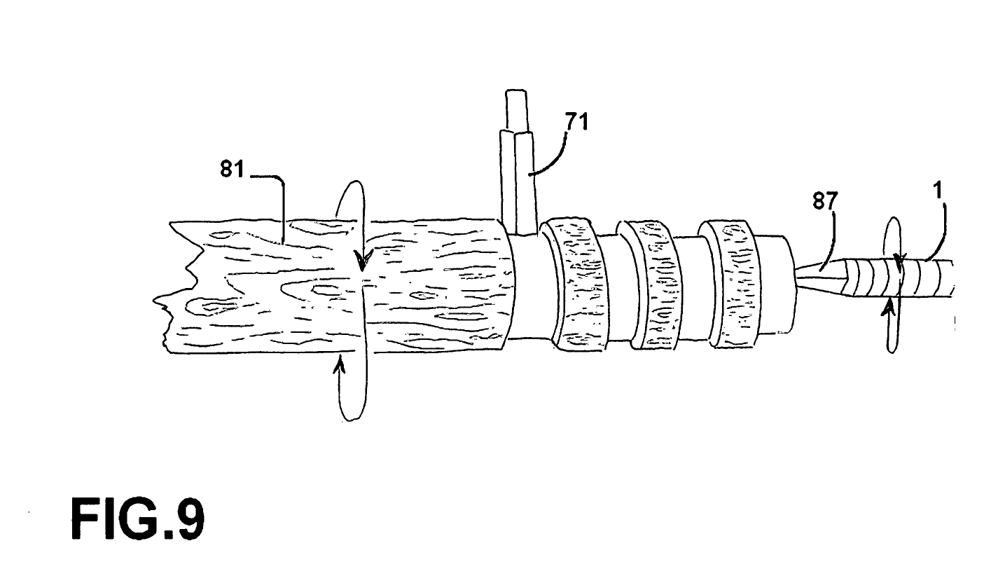

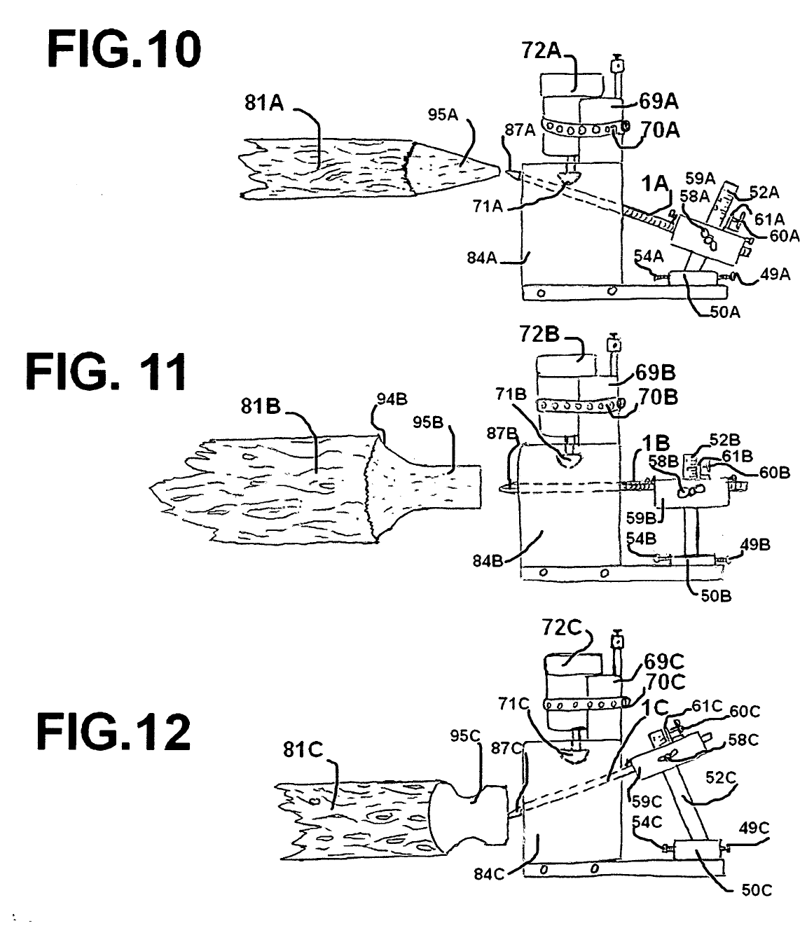

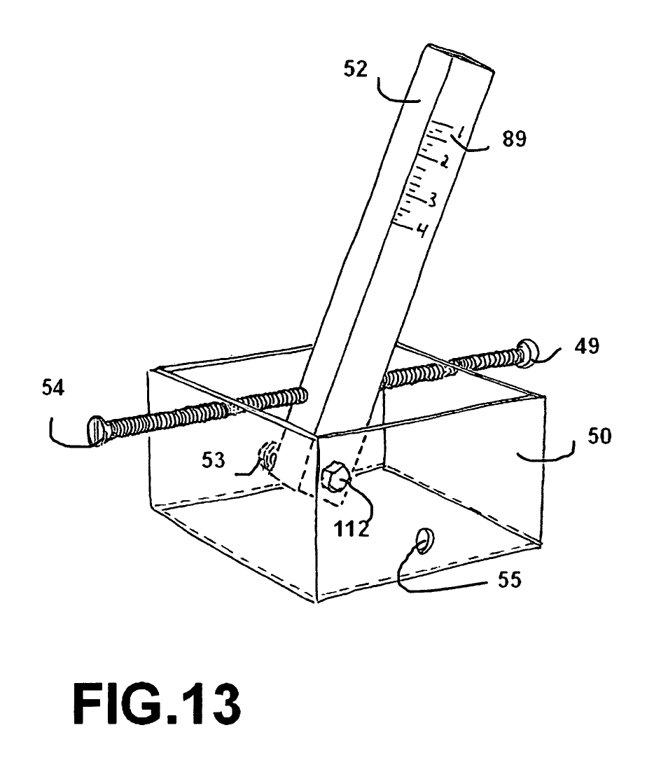

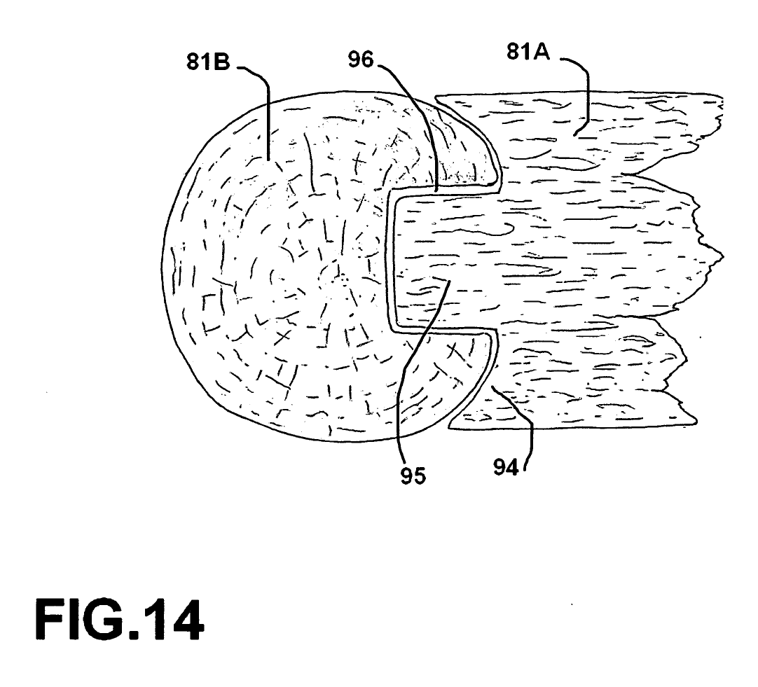

What is disclosed is a method, apparatus, and adjustable tenon making and shoulder forming apparatus for a router or spindle motor. Turning now descriptively to the drawings in which similar reference characters denote similar elements throughout the several views, the attached figures illustrate a tenon making and shoulder forming apparatus which comprising of a attachable stand top 68 that has a slot 109 in the front so the router motor 72 with a router head 71 can be removed without having to remove the router head 71, different types of router heads 71 can be used for forming tenons and shoulders, a two piece router bracket 69 that accepts different diameter router or spindle motors 72 as may be seen in FIG. 8 that bolts to the stand top 68 with three bolts 73,74,75, a hose clamp 70 that secures a router or spindle motor 72 to the two piece router brackets, the stand top 68 uses screws 36,37,38,106,107,108 to attach to two slotted angle brackets 39 and 40, a pair opposing stand sides 84 and 2 screw to the slotted angle brackets 39 and 40 using screws 3,43,42,10,12,14 to support the stand top 68, slotted angle brackets 4 and 46 are bolted to the base of the stand sides 2 and 84 using bolts 47,48,110,111, and nuts 5,6,7 and 113 a slotted angle bracket 46 is attached to square tube 50 using a screw 85. To accomplish an important function of the invention, there is shown in FIG. 13 the adjustable square post 52 for the threaded rod bracket 59 to slide up and down on is bolted to the inside of square tube 50 with one bolt 53 that becomes a pivot point and one nut 112 for locking the square post 52 in place, a adjustment screw 54 and 49 hold the square post at a desired tilt as will be appreciated by reference to FIGS. 10,11 and 12. Very important is the threaded rod bracket that has at least three apertures 59 a square hole cut out to receive the square post 52, another aperture 41 is formed in the threaded rod bracket 59 for receiving a threaded rod 1 wherein a variety of threaded rod 1 with different thread pitches can be used to increase or decrease feed rates, the threaded rod 1 moves slidably within the threaded rod bracket 59, the bore 41 diameter is slightly over the threaded rod 1 diameter to allow the threaded rod 1 to slide freely while still maintaining maximum axial strength, the threaded rod bracket 59 can be raised or lowered in vertical movement allowing the threaded rod 1 to be moved up close to the router head 71 to create smaller diameter tenons or down away from the router head 71 to create larger diameter tenons as will be appreciated by reference to FIG. 3, a wing screw 58 turns into a threaded hole 57 on on the side of the threaded rod bracket 59 until it is tight against the square post 52 to hold the threaded rod bracket 59 a desired vertical height, a angle bracket 61 is attached to the top of the threaded rod bracket with a screw 114, a wing screw 60 is turned into a threaded hole 115 until it tightens up against the square post 52 & stops vertical movement of the threaded rod bracket 59 at a desired height. To accomplish an important function of the invention, there is shown in FIGS. 5 and 6 the curved thread engaging clip 64 that has one aperture 116 for receiving a steel rod 63, the steel rod 63 slides into the bore 118 in the threaded rod bracket 59 a adjustable locking collars 62 and 65 slide on to each end of the steel rod 63 for positioning the curved thread engaging clip 64 in the best engaging and disengaging location on the threaded rod 1 the curved shape 117 on the curved engaging clip 64 is smaller than the outside diameter of the threaded rod 1, Upon inspection of FIG. 5 it will be seen that the square tapered end 87 of the threaded rod 1 allows a wooden work piece 81 with a hole drill in its ends to push against and rotate the threaded rod 1 and engage the curved thread engaging clip 64, Upon inspection of FIG. 6 it will be seen that pulling the wooden work piece 81 back off the square tapered end 87 of the threaded rod 1 disengages the curved thread engaging clip 64. Having observed the details of the thread engaging clip 64 attention may be now given to the threaded rod 1 and it's square tapered end 87, Hand turning wooden work piece 81 with holes on each end against the threaded rod 1 square tapered end 87 creates different types of tenons as illustrated in FIGS. 10,11,12, tilting the threaded rod up as illustrated in FIG. 10 creates a taper on a tenon, keeping the threaded rod 1 level as illustrated in FIG. 11 creates a straight tenon, tilting the threaded rod 1 down as illustrated in FIG. 12 creates a interlocking tenon. Very important is the fact that threads can be cut on a wooden work piece 81 as illustrated in FIG. 9 the threaded rod 1 determines the threads per inch and the width of the router head 71 determines the width of the cut, the depth of the cut is determined by raising or lowering the threaded rod 1, any diameter tenon that's over the outside diameter of the threaded rod can be made as illustrated in FIG. 3 as illustrated in FIG. 4 a wrap around shouldered tenon can be made using a dovetail router head 71. FIG. 14 illustrates a wrap around shouldered tenon joint. In accordance with an important feature of the invention there is shown in FIG. 7 the adjustable wooden work piece 81 holder feature, a round tube 17 with a square tube 18 coming off it at a 90 degree angle, the square tube 18 is a receiver for a smaller square tube 16 that fits slidable in the square tube 18, a larger rectangle tube 91 slides over the smaller square tube 16 a bolt 90 and a nut 97 attaches the rectangle tube 91 to the smaller tube 16, the bolt 90 becomes a pivot for the rectangle tube 91, a threaded hole 99 and 100 are for two wing screws 92 and 93, a fixed stud 83 is welded to the side of the rectangle tube 91, the fixed stud 83 feeds into a drilled hole on one end of a wooden work piece 81 and becomes a pivot point, the fixed stud 83 can be adjusted to where it is in axial alignment with the threaded rod 1 the two wing screws 93 and 92 can be turned into the threaded holes 99 and 100 until the wing screws make contact with the square tube 16 tightening one wing screw more then the other tilts the steel rod 83 up or down, a smaller square tube 16 can slide up and down in the square tube 18, two wing screws 19 and 22 can be turned into the threaded holes 101 and 102, tightening the wing screws against the sliding square tube 16 will lock it in place at a desired adjustment, the round tube 17 slides on the slide pole 23. Upon inspection of FIG. 2 it will be seen that the wooden work piece holder feature allows a person 82 to to hand turn a wooden work piece 81 while having the wooden work piece 81 supported at two points, the fixed stud 83 and the threaded rod 1, a person 82 pushes against the square tube 18 to keep the fixed stud 83 inserted in a drilled hole in the end of the wooden work piece 81, as the person 82 pushes and rotates the wooden work piece 81 against the square tapered end 87 of the threaded rod 1 the threaded rod rotates and feeds the end of the wooden work piece 81 into the router head to cut a tenon. Having observed the details of the wooden work piece 81 holder attention is drawn to FIG. 1 a square tube receiver 78 supported by a square tube 76 and a steel plate 79 that is bolted to the top of the router bracket with bolt 74 receives one end of the slide pole 23, and locks the slide pole 23 in place using the two wing screws 77 and 80, a double steel tube connector 28 that accepts and receives the slide pole tubing 23 and holds it in a horizontal position and accepts the stand pole tubing 31 and holds it in a vertical position, the slide pole tubing 23 and the stand pole 31 are locked in place in the double steel receiver 28 using the four wing screws 24,25,26 and 27, a stand base with a square tube 87 with two square tube feet 34 and 88, a square tubing receiver 35 for supporting the stand pole tubing 31 two wing screws for securing the stand pole tubing 31 in the square tube receiver 35

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Apparatus for making tenons and forming shoulders on wood ends comprising:
a stand having two opposing sides and a attachable stand top with a slot for receiving a router head;
a angle bracket bolted to the base of the stand sides;
a two piece router bracket that accepts different diameter router motors.
a clamp for securing a router or spindle motor to the router bracket;
a router or spindle motor;
a router head for forming tenons and shoulders on the ends of wooden work pieces;
a square steel tube with a attached angle bracket bolted to a stand side angle bracket;
a threaded rod bracket with at least 3 apertures for receiving a threaded rod, square post and steel rod;
a threaded rod with a square tapered end;
a square steel tube bolted on the inside of a larger square steel tube with one bolt;
a curved thread engaging clip with one aperture;
a steel tube connector that receives and secures smaller round diameter tubing and bolts to the top of the router bracket;
a round steel slide pole;
a double steel tube connector that receives tubing and secures one tube in a vertical position and one tube in a horizontal position;
a base with a steel tube receiver that accepts steel pole tubing and secures the tubing in a vertical position;
a wooden work piece holder with a round tube with a square tube attached at a 90 degree angle
a a square tube with a fixed stud at one end.

2. Apparatus for making tenons and forming shoulders on wood ends as claimed in claim 1 wherein a variety of threaded rods with different thread pitches can be used to increase or decrease feed rates.

3. Apparatus for making tenons and forming shoulders on wood ends as claimed in claim 1 wherein the threaded rod with more than one thread pitch.

4. Apparatus for making tenons and forming shoulders on wood ends as claimed in claim 1 wherein the position of the threaded rod can be adjusted.

5. Apparatus for making tenons and forming shoulders on wood ends as claimed in claim 1 wherein the threaded rod moves slid ably with-in the threaded rod bracket.

6. Apparatus for making tenons and forming shoulders on wood ends as claimed in claim 1 wherein said threaded rod has a square taper at one end to allow a wooden work piece with a drilled hole to push against the tip and rotate the threaded rod.

7. Apparatus for making tenons and forming shoulders on wood ends as claimed in claim 1 wherein said threaded rod bracket moves slidably up and down on a square post

8. Apparatus for making tenons and forming shoulders on wood ends as claimed in claim 1 wherein said curved thread engaging clip moves slidably on a steel rod.

9. Apparatus for making tenons and forming shoulders on wood ends as claimed in claim 8 further comprising locking collars used as adjustable stops positioning the curved engaging clip in a engaging and disengaging location on the threaded rod.

10. Apparatus for making tenons and forming shoulders on wood ends as claimed in claim 1 wherein said square tube with a fixed stud fits slidably within the square tube that attaches at a 90 degree angle off the round tube on the wooden work piece holder.

11. Apparatus for making tenons and forming shoulders on wood ends as claimed in claim 10 wherein said square tube with a fixed stud can be adjusted to axial alinement's with the threaded rod.
